(19) United States
(12) Patent Application Publication
(10) Pub. No.: US 2006/0280536 A1
(43) Pub. Date: Dec. 14, 2006

(54) Sheet conveyance apparatus

(75) Inventors: Hideo Isohara, Tokyo (JP); Satoshi Hamaya, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Business Technologies, Inc.

(21) Appl. No.: 11/388,420

(22) Filed: Mar. 24, 2006

(30) Foreign Application Priority Data
Jun. 9, 2005 (JP) JP2005-169219

(51) Int. Cl. G03G 15/00

(52) U.S. Cl. 399/401

(57) ABSTRACT

A sheet convayance apparatus includes a switchback path in which a sheet is conveyed, paired sheet edge stop rollers arranged along the switchback path, capable of being rotated forwardly or reversely, and a controller for controlling a drive of the paired sheet edge stop rollers so that a collision of and edge of the sheet with the paired sheet edge stop rollers and a switching of a conveyance direction of the sheet are performed by a single stop operation of the sheet.

This application is based on Japanese Patent Application No. 2005-169219 filed on Jun. 9, 2005, which is incorporated hereinto by reference.

### BACKGROUND OF THE INVENTION

The present invention relates to a sheet conveyance apparatus for use in an image forming apparatus, particularly to a sheet conveyance apparatus equipped with a controller for correcting paper skew.

The sheet fed to a conveyance path is liable to have skew (hereinafter referred to as “sheet skew”) in the process of conveyance. The sheet is skewed especially when reversed in the double-sided image formation mode, and has a problem of registration failure with respect to the already printed front image. FIG. 3 shows a switchback path and sheet skew correction method proposed to solve this problem.

FIG. 3 is a diagram representing an example of the transfer material conveyance path for double-sided image formation.

In FIG. 3, sheet 127 fed by sheet feed roller 110 is temporarily stopped by timing roller 112, and is restarted in synchronism with the toner image formed on photoreceptor 121. The aforementioned toner image transferred to the sheet by transfer roller 113. The sheet carrying the toner image is separated from the photoreceptor by separating and discharging unit 115, and is fixed by fixing unit 119. The sheet is conveyed along first conveyance path 116 as it is interposed by roller 101, conveyance switching member 117 indicated by a solid line and switchback roller 175. Then it enters switchback path 109, and stops with the trailing edge of the sheet (with respect to conveyance direction) being interposed. Then the switchback roller 175 is reversed and the sheet goes through the conveyance switching member 117 in the state illustrated by dotted line. Then the sheet is reversed where the trailing edge serves as the leading edge, and enters second conveyance path 114 linked with the switchback path 109. Further, the sheet is conveyed as it is interposed by rollers 102 and 103, and enters the conveyance roller path (between rollers 103 and 104) so that the leading edge is corrected. After that, the roller 104 rotating in the direction different from the roller 103 is rotating for a predetermined time. This procedure causes a loop to be formed on the sheet. The sheet is made to conform to the roller 104, with the result that sheet skew is corrected through paper stiffness. After that, the roller 104 rotates in the forward direction so that the transfer material sheet continues to be conveyed. The sheet is fed to the timing roller 112 by rollers 105, 106 and 107. With the sheet kept in the reversed position, an image is formed on the rear of the sheet (for example, Patent Document 1).

[Patent Document 1] Unexamined Japanese Patent Publication No. 2000-255840.

However, the aforementioned proposal requires the transfer material to be stopped twice (for forward and reverse operations) in the switchback path for changing the direction of the transfer material and the conveyance roller path for correcting the leading edge provided independently in combination therewith. This raises the problems of reduced printing productivity, reduced reliability of mechanical operation resulting from increased transfer material conveyance speed in order to make up for the reduced reliability, and a cost increase.

### SUMMARY OF THE INVENTION

The present invention has any one of the following structures (1) and (2).

Structure (1): A sheet conveyance apparatus including: a switchback path for conveyance of a sheet; a reversible paired sheet edge stop rollers arranged along the switchback path; and a controller for controlling a drive of the paired sheet edge stop rollers to ensure that collision of the sheet edge with the paired sheet edge stop rollers and switching of the sheet conveyance direction are performed by a single sheet stop operation.

Structure (2): An image forming apparatus including an image forming section for forming an image, and a sheet conveyance apparatus according to Structure (1) for conveying a sheet to the image forming section.

### BRIEF DESCRIPTION OF THE DRAWINGS

FIG. 1 is a schematic view representing the overall structure of an image forming apparatus;

FIG. 2 is an enlarged view of the switchback path having a function of correcting the sheet skew; and

FIG. 3 is a diagram representing an example of a transfer material conveyance path for double-sided image formation mode.

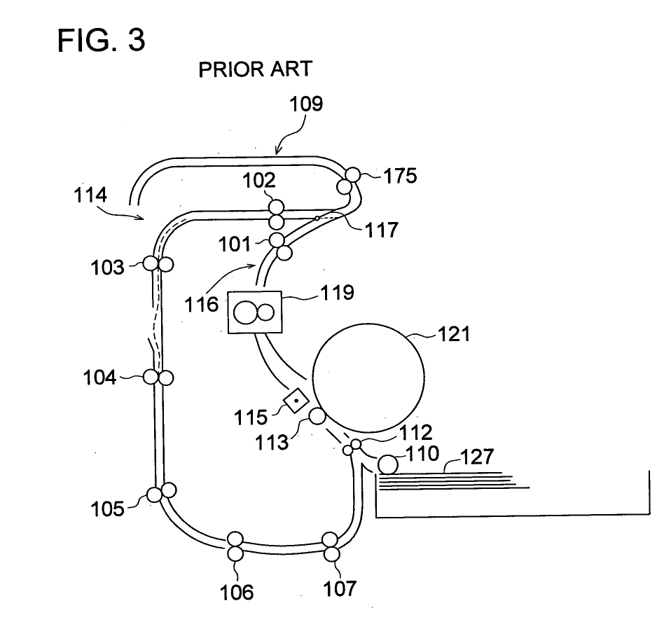

### DETAILED DESCRIPTION OF THE PREFERRED EMBODIMENT

The following describes the image forming apparatus of the present invention.

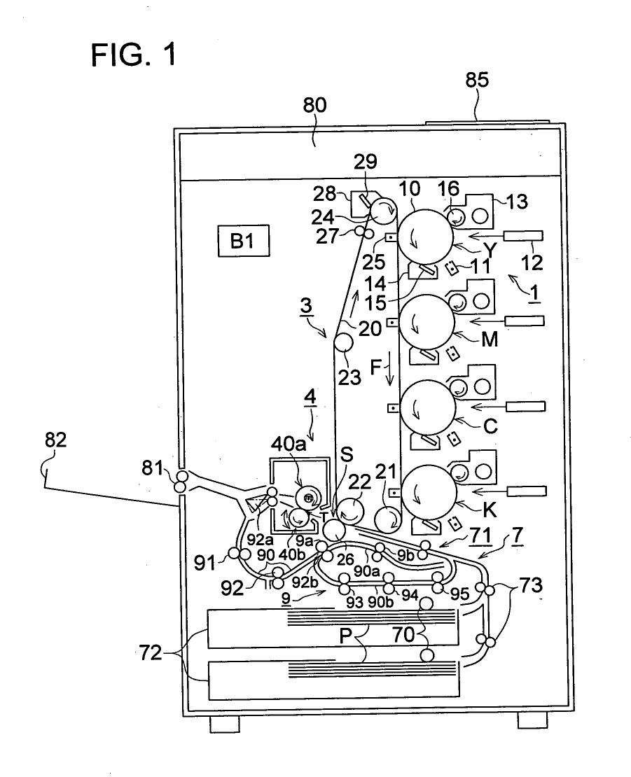

FIG. 1 is a schematic view representing the overall structure of an image forming apparatus.

In FIG. 1, reference numeral 10 denotes a photoreceptor, 11 a scorotron charging unit as a charger, 12 a writing device for writing an image, 13 a developing device for development, 14 a cleaning device for cleaning the surface of the photoreceptor 10, 15 a cleaning blade, 16 a developing sleeve, and 20 an intermediate transfer belt. The image forming device 1 is made up of photoreceptor 10, scorotron charger 11, developing device 13, cleaning device 14 and others. The mechanical structures of the image forming device 1 of various colors are the same. Accordingly, in FIG. 1, the structural components only for Y (yellow) color are provided with reference numerals. The components for M (magenta), C.(cyan) and K (black) are not .provided with reference numerals.

The image forming devices 1 for each color are arranged in the order of Y, M, C and K in the direction of travel of the intermediate transfer belt 20. Each photoreceptor 10 is kept in contact with the stretched surface of the intermediate transfer belt 20 and rotates at the constant linear speed in the same direction as the traveling direction of the intermediate transfer belt 20 at the point of contact.

The intermediate transfer belt 20 is entrained about a drive roller 21, earth roller 22, tension roller 23, electric charge elimination roller 27 and follower roller 24. These rollers, intermediate transfer belt 20, transfer device 25 and cleaning device 28 constitutes a belt unit 3.

The traveling of the intermediate transfer belt 20 is provided by the rotation of a drive roller 21 driven by a drive motor (not illustrated).

The photoreceptor 10 is produced, for example, by forming a conducting layer, a-Si layer or photosensitive layer such as an organic photoreceptor (OPC) on the outer periphery of a cylindrical metallic substrate formed of an aluminum material. With the conducting layer connected to the ground, the photoreceptor 10 rotates counterclockwise as indicated by the arrow in FIG. 1.

The electrical signal corresponding to the image data from the reading device 80 is converted into an optical signal by an image forming laser, and is projected onto the photoreceptor 10 by the writing device 12.

Keeping a predetermined spacing with respect to the peripheral surface of the photoreceptor 10, the developing device 13 has a developing sleeve 16 formed of a cylindrical non-magnetic stainless steel or aluminum material that rotates in the direction opposite to the rotation direction of the photoreceptor 10.

The intermediate transfer belt 20 is an endless belt having a specific volume resistance of 10⁶ through 10¹² Ω·cm. For example, it is a semiconducting seamless belt having a thickness of 0.04 through 0.10 mm formed by dispersing the conducting material in the engineering plastics such as modified polyimide, thermosetting polyimide, ethylene tetrafluoro ethylene copolymer, vinylydene polyfluoride and nylon alloy.

The reference numeral 25 denotes a transfer device. It is provided with a direct current having a polarity opposite to that of the toner. It has,a function ensuring that the toner image formed on the photoreceptor 10 is transferred onto the intermediate transfer belt 20. A transfer roller in addition to the corona discharge device can be used as a transfer device 25.

The reference numeral 26 denotes a transfer roller that can be contacted from the earth roller 22, wherein the contact can be released. The toner image formed on the intermediate transfer belt 20 is re-transferred onto the transfer material P as a sheet.

The reference numeral 28 denotes a cleaning device. It is arranged opposite to the follower roller 24 with the intermediate transfer belt 20 located in-between. After the toner image has been transferred onto the transfer material P, the intermediate transfer belt 20 is provided with the A.C. voltage on which the D.C. voltage having the same polarity or a reverse polarity to that of the toner is superimposed. The remaining toner charge is reduced by the electric charge elimination roller 27, and the toner remaining on the peripheral surface is removed by the cleaning blade 29. The reference numeral 4 denotes a fixing device, and is constituted by a cylindrical heat roller 40a formed of an aluminum material incorporating a halogen heater, and a pressure roller 40b that can be pressed against this heat roller 40a by a mechanism (not illustrated), in which the pressure can be reduced to detach the pressure roller 40b from this heat roller 40a.

The following sheet conveyance feed apparatuses are arranged below the image forming apparatus.

The reference numeral 7 indicates a conveyance path, 70 a sheet feed roller, 71 a timing roller, 72 a sheet feeding cassette, and 73 a conveyance roller.

The reference numeral 81 denotes conveyance (ejection) roller, 82 an ejection tray and 85 an operation panel.

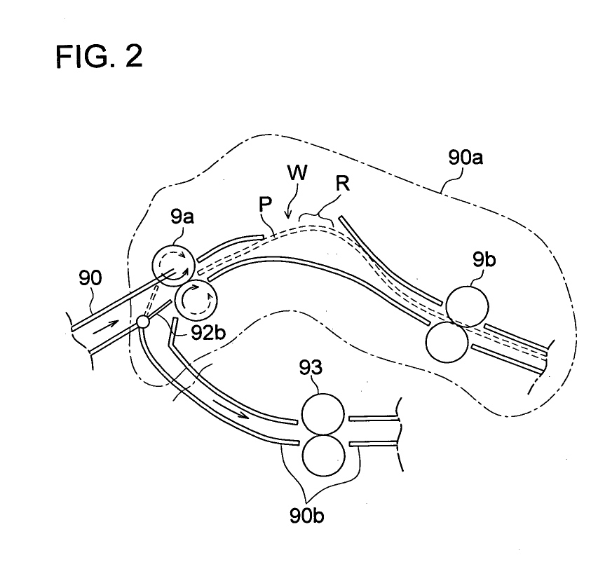

The reference numeral 9 represents an automatic sheet re-feed mechanism (ADU mechanism). In the double-sided image formation mode, the transfer materials with a toner image fixed on one side placed in the state shown by the solid line are distributed through the conveyance switching member 92a. They are led to the sheet reverse path 90 by paired conveyance rollers 91 and 92. Passing through the conveyance switching member 92b placed in the state indicated by the solid line, the transfer materials are fed by the forward and reverse rotation rollers 9a to reach the switchback path 90a provided with an aperture W (refer to FIG. 2). The details of the switchback path will be described later.

B1 indicates a controller for controlling the drive section, image formation process and fixing temperature.

The following describes the image formation process with reference to FIG. 1.

With the start of image recording, the drive motor of the photoreceptor drum (not illustrated) starts operation to rotate the photoreceptor 10 of the yellow (Y) image forming device 1 in the arrow-marked direction. At the same time, the charging action of the scorotron charger 11 allows potential to be applied to the photoreceptor 10.

After potential has been applied to the photoreceptor 10, the exposure optical system 12 allows an image to be written by the first color signal, namely, electrical signal corresponding to the Y-color image data. The electrostatic latent image corresponding to the Y-color image is formed on the surface of the photoreceptor 10.

The aforementioned latent image is subjected to reverse development in the state of non-contact by the developing device 13. The yellow (Y) toner image is formed in response to the rotation of the photoreceptor 10.

The Y-color toner image on the photoreceptor 10 formed by the aforementioned image formation process is transferred to the intermediate transfer belt 20 by the transfer device 25.

Then the intermediate transfer belt 20 is synchronized with the Y-color toner image and is provided with potential by the magenta (M) image forming device 1 through the charging action of the scorotron charger 11. The writing device 12 allows an image to be written by M-color signal, namely, the electrical signal corresponding to the M-color image data. The M-color toner image formed on the photoreceptor 10 by the non-contact reverse development by the developing device 13 is superimposed on the Y-color toner image by the M-color transfer device 25.

In the similar process, synchronization with the Y- and M-color superimposed toner image is provided. The C-color toner image corresponding to the C-color image data through the C-color color signal formed on the photoreceptor 10 by the cyan (C) image forming device 1 is formed in the state superimposed on the aforementioned Y- and M-color toner image by the C-color transfer device 25. Further, synchronization with the Y-, M- and C-color superimposed toner image is provided. The K-color toner image corresponding to the K-color image data through the K-color color signal formed on the photoreceptor 10 by the black (K) image forming device 1 is formed in the state superimposed on the Y-, M- and C-color toner image. The Y, M, C and K color superimposed color toner image is superimposed on each of the intermediate transfer belts 20, whereby a color toner image is formed.

Further, the cleaning unit 14 removes the remaining toner from the toner remaining on the photoreceptor 10 of each color subsequent to primary transfer. The hysteresis is removed from the photoreceptor 10 of the aforementioned image formation by the uniform exposure device prior to charging (not illustrated). Then the next image formation cycle starts.

The intermediate transfer belt 20 carrying the superimposed toner image is fed in the direction marked by arrow F. The transfer material P is fed by the feed roller 70 from the sheet feeding cassette 72 as a transfer material storing unit through the conveyance roller 73, and is conveyed to the timing roller 71. Synchronized with the toner image on the intermediate transfer belt 20, the transfer material P is fed to the transfer region S of the transfer roller 26 by the drive of the timing roller 71.

In the transfer region S, the toner image superimposed on the intermediate transfer belt 20 is transferred onto the transfer material P interposed by the earth roller 22 and transfer roller 26. Pressure is applied to the transfer material P interposed by the heat roller 40a and pressure roller 40b, and the image is fixed to the transfer material P by the fixing device 4. In the case of single-sided printing, the transfer material P passes through the conveyance switching member 92a in the state of one-dot chain line and is ejected from the ejection roller 81 to the ejection tray. In the case of double-sided printing, after fixing, the transfer material P is fed to the sheet reverse path 90 by the conveyance switching member 92a in the state indicated by the solid line, and is reversed by the aforementioned automatic sheet re-feed mechanism (Automatic Duplex Unit). The transfer material P is conveyed to the timing roller 71 by the conveyance rollers 93, 94 and 95 through the conveyance path 90b. Synchronized with the toner image on the intermediate transfer belt 20 and driven by the timing roller 71, the transfer material P is fed to the transfer region S of single-sided printing, and is ejected through the same process as that in the single-sided printing.

As described above, the transfer material having been fed to the conveyance path is susceptible to sheet skew during the process of conveyance. The sheet is skewed especially when reversed in the double-sided image formation, and registration failure occurs with respect to the already printed front image.

The present invention ensures switching of the direction for transfer material conveyance and correction of sheet skew to be performed by one forward and reverse operation of the paired transfer material edge stop rollers (stop of the transfer material), with the result that printing productivity is improved.

The following describes an embodiment of the switchback path of the transfer material of the present invention.

FIG. 2 is an enlarged view of the switchback path having a function of correcting the sheet skew given in FIG. 1.

In FIG. 2, the conveyance switching member 92b is located at the extreme upstream side of the switchback path 90a. The controller B1 provides control in such a way that the state indicated by the solid line will be maintained when the forward and reverse rotation rollers 9a as paired transfer material edge stop rollers are rotated in the forward direction (indicated by an arrow in solid line), and the state indicated by the solid line will be maintained when the forward and reverse rotation rollers 9a are rotated in the reverse direction (indicated by an arrow in dotted line).

The transfer material having been fed from the sheet reverse path 90 passes through the conveyance switching member 92b maintained in the state indicated by the solid line, and is interposed between forward and reverse rotation rollers 9a of the switchback path 90a having at least two or more pairs of rollers. The transfer material is further interposed between switchback rollers 9b as paired rollers provided downstream of the switchback path 90a. The conveyed position of the switchback rollers 9b is detected by a paper sensor (not illustrated) along the switchback path 90a. The switchback rollers 9b are stopped under the control of the controller B1 before the trailing edge of the transfer material passes completely through the forward and reverse rotation rollers 9a. In the embodiment of the present invention, the rotation of the switchback rollers 9b stops when the remaining length of the trailing edge of the transfer material is 3 through 15 mm in the conveyance of the transfer material by the forward and reverse rotation rollers 9a. The leading edge of the transfer material is interposed between switchback rollers 9b and is held in a stopped position. The forward and reverse rotation rollers 9a continue to feed the trailing edge of transfer material counter to the stiffness of the sheet. Thus, a loop R is formed on the transfer material. The loop R is projected from the aperture W, and the trailing edge of transfer material is released from the grip by the forward and reverse rotation rollers 9a. The forward and reverse rotation rollers 9a are stopped. To put it another way, the trailing edge of the transfer material (leading edge in the case of reverse rotation) accurately conforms to the shape between the paired rollers of the forward and reverse rotation rollers 9a due to the stiffness of the sheet. The transfer material is made parallel to the paired rollers so that the sheet skew can be easily corrected. Thus, sheet skew is corrected. After that, all the paired rollers inside the switchback path 90a are rotated in the reverse direction. After the sheet skew has been corrected, the transfer material is fed to the conveyance path 90b through the conveyance switching member 92b having been switched to the state indicated by the dotted line. This brings the system to the process of forming of an image on the rear.

It is also possible to make such arrangements that, when the switchback rollers 9b holding and conveying the transfer material have been stopped at a timed interval, the rotation speed of the forward and reverse rotation rollers 9a is increased at a predetermined rate so that a loop is formed. The forward and reverse rotation rollers 9a are stopped when the trailing edge of transfer material has been released, transfer-material is brought into contact with the forward and reverse rotation rollers 9a by the stiffness of the looped sheet, whereby the sheet skew is corrected.

The present invention uses a simple and less costly apparatus structure to ensure switching of the direction for transfer material conveyance and correction of sheet skew by contact of the leading edge of the transfer material to be performed by one operation of the transfer material stop rollers. This structure improves printing productivity.

In this embodiment, the present invention is employed when the transfer material is reversed in the double-sided image formation process. The present invention can also be applied to the document reversing section when the document is reversed in the automatic document feeder (ADF).

The conveyance efficiency of the document as a sheet is improved by using the present invention in the document reversing section of the automatic document feed apparatus. This ensures increased document image reading speed. The present invention can also be applied to the sheet convayance apparatus of an inkjet printer and others.

What is claimed is:

1. A sheet conveyance apparatus comprising:
(a) a switchback path in which a sheet is conveyed;
(b) paired sheet edge stop rollers arranged along the switchback path, capable of being rotated forwardly or reversely; and
(c) a controller for controlling a drive of the paired sheet edge stop rollers so that a collision of an edge of the sheet with the paired sheet edge stop rollers and a switching of a conveyance direction of the sheet are performed by a single stop operation of the sheet.

2. The sheet conveyance apparatus of claim 1, further comprising paired switchback rollers provided downstream of the paired sheet edge stop rollers in a forward conveyance direction of the paired sheet edge stop rollers, the paired switchback rollers capable of being rotated forwardly or reversely.

3. The sheet conveyance apparatus of claim 2, wherein the controller controls a drive of the paired switchback rollers.

4. The sheet conveyance apparatus of claim 3, wherein the controller drives the paired sheet edge stop rollers and the paired switchback rollers to rotate forwardly, and stops a forward rotation drive of the paired switchback rollers after the paired switchback rollers interpose a leading edge of the sheet, and before a trailing edge of the sheet reaches the paired sheet edge stop rollers.

5. The sheet conveyance apparatus of claim 4, wherein the controller stops a forward rotation drive of the paired sheet edge stop rollers after the controller stops the forward rotation drive of the paired switchback rollers and after the trailing edge of the sheet passes through the paired sheet edge stop rollers.

6. The sheet conveyance apparatus of claim 5, wherein the controller carries out concurrently a reverse rotation drive of the paired sheet edge stop rollers and the paired switchback rollers after the controller stops the forward rotation drive of the paired sheet edge stop rollers.

7. An image forming apparatus comprising:
an image forming section for forming an image; and
the sheet conveyance apparatus of claim 1, which conveys a sheet to the image forming section.

8. The image forming apparatus of claim 7, wherein the sheet conveyance apparatus reverses a sheet on one side of which an image has been formed.
